(19) United States
(12) Patent Application Publication
(10) Pub. No.: US 2014/0322383 A1
(43) Pub. Date: Oct. 30, 2014

(54) GLOUCESTER PRINT HEAD

(71) Applicant: Andrew Rutter, San Francisco, CA (US)

(72) Inventor: Andrew Rutter, San Francisco, CA (US)

(21) Appl. No.: 14/262,441

(22) Filed: Apr. 25, 2014

Related U.S. Application Data
(60) Provisional application No. 61/815,828, filed on Apr. 25, 2013.

(51) Int. Cl. B29C 67/00

(52) U.S. Cl. CPC B29C 67/0085
USPC 425/500

(57) ABSTRACT

A print head is described for use in a computer controlled machine that uses fused filament fabrication to produce a three dimensional object.

### CROSS-REFERENCE TO RELATED APPLICATIONS

This application claims a priority benefit of U.S. Provisional Application No. 61/815,828, filed Apr. 25, 2013, entitled “GLAUCESTER PRINTER HEAD,” which is incorporated herein by reference in its entirety.

### BACKGROUND

Three dimensional objects have been manufactured using fused filament fabrication techniques in which a fabrication material is heated to a flowable state and is deposited upon previously deposited solidified layers of the material in a pattern determined based upon design information provided within a mathematical computer aided design (CAD) model. The material is heated to the flowable state and is deposited layer-by-layer upon previously deposited layers that have cooled sufficiently to be in a adequately solidified state to provide a structurally stable layer for deposition of a new layer. Each successive newly deposited layer cools, solidifies and adheres to a previously deposited layer of material with an adequate bond upon solidification. In this manner, layers of material progressively build up and solidify to form a three-dimensional object resembling the CAD model.

The fabrication material is fed to a print head, sometimes referred to as an extrusion head that inputs the material in a solid state, heats it to a flowable state, and outputs the fabrication material in the flowable state for deposition in the pattern determined by the CAD model. The print head ordinarily includes a liquefier, a dispensing nozzle and a drive mechanism. The drive mechanism drives the material in a solid state to the liquefier and drives the flowable liquefied material from the liquefier out through the nozzle for deposition onto the object that is under construction.

In the past, a drive roller and idler roller pair have been used to advance a flexible filament fabrication material, in a solid state, through print head. As the roller pair advanced the filament into the print head, the incoming filament strand melts as it passes through the liquefier. The solid state filament applies a force on the melted, liquefied state, filament material causing it to be extruded out from the dispensing nozzle where it is deposited onto previously extruded solidified layers of the material mounted upon a build platform. The flow rate of the material extruded from the nozzle is a function of the rate at which the filament is advanced to the head and the size of the dispensing nozzle orifice.

The print head typically is moveably mounted upon a support structure. Motors are provided to move of the print head within a horizontal x, y plane parallel to the build platform and to move the platform in a vertical z-direction perpendicular to the plane of movement of the print head. An electronic controller controls the motors to control movement of the print head in the horizontal plane and to control z-direction movement of the build platform. The controller also controls the rate at which the drive mechanism advances the material through the print head. By controlling these processing variables in synchrony, the material is deposited at a desired flow rate in pattern, layer-by-layer, in areas defined from the CAD model. The dispensed material solidifies upon cooling to create a three-dimensional solid object.

The dispensing nozzle often is incorporated as a part of a disposable component sometimes referred to as a ‘hot end’ in which the phase transformation of a filament from solid to liquid occurs. The dispensing nozzle is formed of a highly heat conductive metal, typically brass. The filament is fed to the nozzle though an elongated pipe, or barrel, also formed of metal. The phase transition takes place within the pipe. A solid state filament material is fed in one end of the metal pipe, and liquid state material flows out from the other end of the pipe to the dispensing nozzle. The disposable component comprising the dispensing nozzle periodically requires replacement often because foreign matter accumulates inside resulting in irregular flow or even blockage. For example, solid fragments of the modeling material may become lodged inside the pipe due to turning on and off the liquefier resulting in molten material solidifying within the component.

### BRIEF DESCRIPTION OF THE DRAWINGS

FIG. 1 is an illustrative drawing representing a computer controlled machine that uses fused filament fabrication to produce a three dimensional object that represents a three dimensional model stored in a computer readable memory device in accordance with some embodiments.

FIG. 2A is a perspective view of a print head in accordance with some embodiments.

FIG. 2B is a side elevation view of the print head of FIG. 2A in accordance with some embodiments.

FIG. 2C is an exploded view of the print head of FIG. 2A in accordance with some embodiments.

FIG. 3 is an illustrative partial cross sectional view of the hot end element groove mounted within the first clamp plate of the print head of FIGS. 2A-2C in accordance with some embodiments.

FIGS. 4A-4B are illustrative drawings that show first opposed facing surfaces of the clamp plates of the print head of FIGS. 2A-2C in accordance with some embodiments.

FIG. 5 is an illustrative view of a portion of the side elevation view of FIG. 2B but with the second (top) plate removed to show the upper face of the first (bottom) clamp plate and showing the spring and lever mechanisms partially in cut away and partially with phantom lines in accordance with some embodiments.

FIG. 6 is a side view of a driver roller in accordance with some embodiments.

### DESCRIPTION OF EMBODIMENTS

The following description is presented to enable any person skilled in the art to make and use a print head for use in a computer controlled machine that uses fused filament fabrication to produce a three dimensional object according to a computer aided design (CAD) model stored in a computer readable storage device. Various modifications to the embodiments will be readily apparent to those skilled in the art, and the generic principles defined herein may be applied to other embodiments and applications without departing from the spirit and scope of the invention. Moreover, in the following description, numerous details are set forth for the purpose of explanation. However, one of ordinary skill in the art will realize that the invention can be practiced without the use of these specific details. Identical reference numerals may be used in this disclosure to represent different views of the same item in different drawings. Thus, the present invention is not intended to be limited to the embodiments shown, but is to be accorded the widest scope consistent with the principles and features disclosed herein.

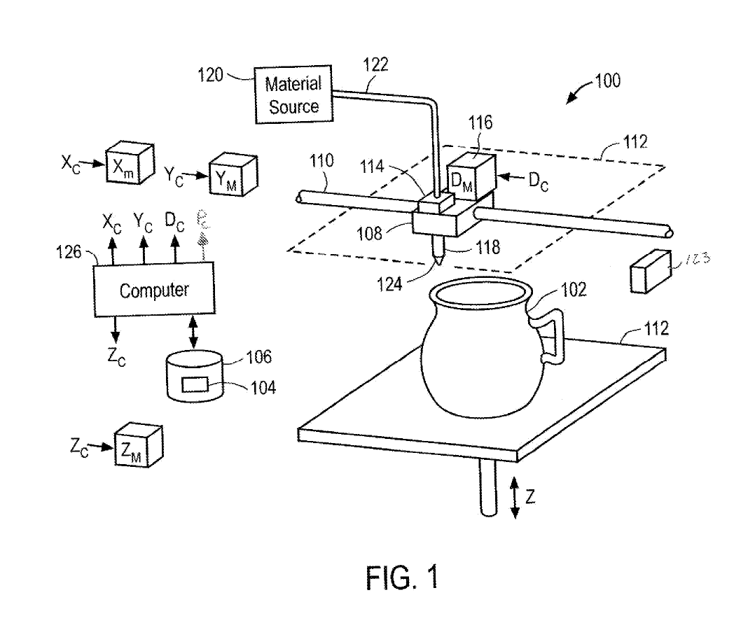

FIG. 1 is an illustrative drawing representing a computer controlled machine 100 that uses fused filament fabrication to produce a three dimensional object 102 that represents a three dimensional model 104 stored in a computer readable memory device 106 in accordance with some embodiments. A print head 108 is mounted on a support structure 110 that is configured to enable movement of the print head in a horizontal x, y plane that is indicated by dashed lines. A base platform 112 that is moveable in a vertical z-direction is disposed beneath the print head 108. The object 102 that is under construction sits upon the platform 112.

The print head 108 includes a filament drive mechanism 114, a drive motor 116 and a hot end 118. A fabrication material source 120 is coupled to feed a continuous filament (not shown) through an elongated tube 122 to the print head 108 in response to the filament drive mechanism 114. In some embodiments, the elongated tube 122 interconnects the material source 120 and the filament drive mechanism 114. The drive motor 116 is coupled to drive the filament drive mechanism 114 so as to advance the filament from the drive source 120 to the hot end 118. The hot end 118 includes a dispensing nozzle 124 and a liquefier (not shown). The liquefier heats the filament causing it to undergo a phase change from solid to liquid. The nozzle dispenses the material in molten, liquid, form.

A cooling element such as a fan 123 is disposed to rapidly cool the liquefied material once it has been dispensed from the nozzle. In some embodiments, the fabrication material, upon being dispensed from the nozzle, comprises low viscosity plastic that has a high heat retention. For example, in some embodiments, the material comprises a thermoplastic such as PLA, ABS, EVA, PVA or Nylon, for example. The cooling element is used to rapidly cool the material so that it is sufficiently solid when the next layer is dispensed to avoid distortion of the shape of the fabricated object.

A computer 126 provides x-direction control signals X_{c}, y-direction control signals Y_{c}, z-direction control signals Z_{c} and filament drive control signals D_{c}, respectively, to an X-motor Xₘ, Y-motor Yₘ, Z-motor Zₘ and D-motor Dₘ as indicated. In addition, the computer provides piston plunger control signals P_{c} to control the motion of a piston (not shown) used to clean out filament residue as explained more fully below. The control signals are provided in response to the CAD design file 104 stored in a computer readable device 106. The control signals X_{c}, Y_{c}, control the X-motor and Y-motor to control x, y position of the movement print head 108. The control signals Z_{c} control the Z-motor to control the z-position of the base platform 112. It will be appreciated that in some embodiments, the base platform 112 is moved progressively vertically downward as additional layers are added to the object 102 that is under construction. The control signals D_{c} control the D-motor to control the rate at which the filament is driven from the source 120 and to the hot end 118, and therefore, regulates the material dispensing rate. Details of positioning and movement control of the print head 108 and of the base platform 112 and control of the dispensing rate will be understood by those skilled in the art need not be described in detail herein.

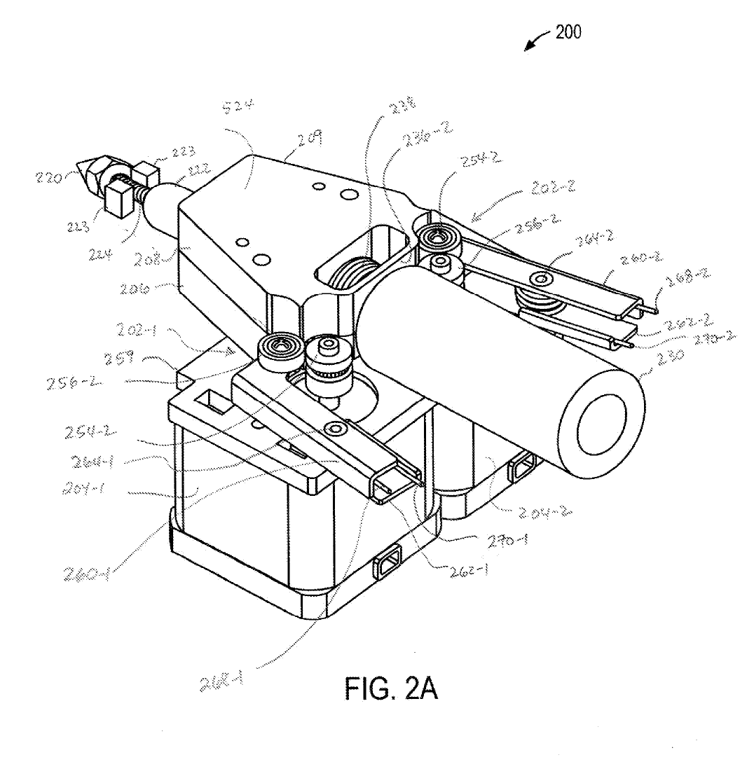

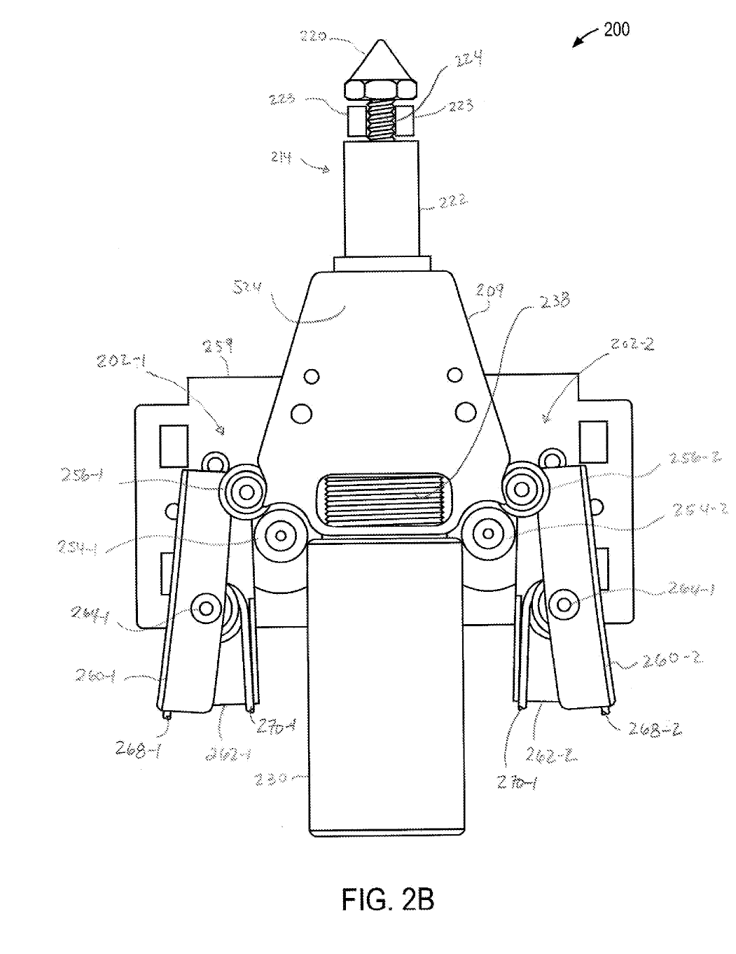

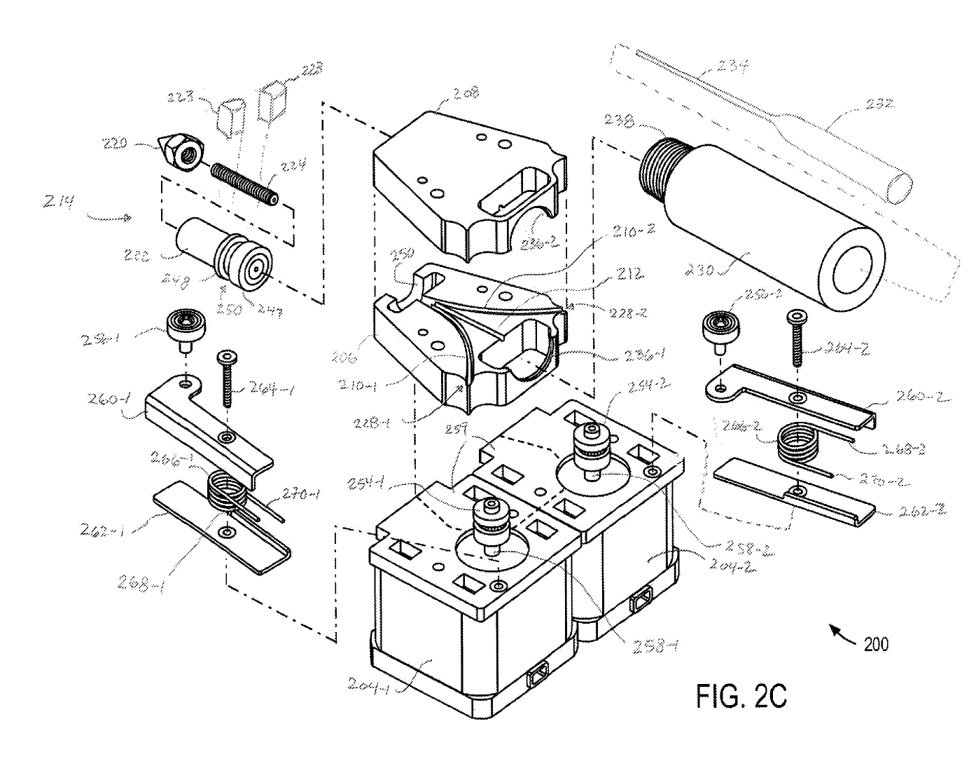

FIGS. 2A-2C provide a perspective view, side elevation view and exploded view, respectively, of a print head 200 configured to alternately dispense molten filament material from either of two filaments in accordance with some embodiments. The print head 200 includes first and second filament drive mechanisms 202-1 and 202-2 that are powered by first and second drive motors 204-1, 204-2, respectively. First and second clamp plates 206, 208 together form a block 209 that defines within it a first filament guide passage 210-1, a second filament guide passage 210-2 and a cleaning plunger passage 212. A removable hot end 214 secured to the block 209 defines a phase change 216 passage that provides a path for filament material flow from the block 209, through a liquefier 218 to a dispensing nozzle 220. The hot end 214 includes a thermally insulating housing 222 and a thermally conductive pipe 224 encompassed within the housing 222. The liquefier 218 includes heating elements 223 that heat a portion of the pipe 224 that protrudes from the housing 222 distal from the block 209 and adjacent the nozzle 220. In the course of passage through the phase change passage 216, the filament changes phase from a solid phase to a molten phase. It will be appreciated that the material that forms the filament melts to a liquid form by the time it reaches the dispensing nozzle 220.

Referring to FIGS. 2C, 4A, 4B and 5 the first filament guide passage 210-1 is defined by first grooves 502-1, 502-2 in the respective first and second clamp plates 206, 208. The second filament guide passage 210-2 is defined by second grooves 504-1, 504-2 in the respective first and second clamp plates 206, 208. The plunger guide passage 212 is defined by respective third grooves 506-1, 506-2 in the respective first and second clamp plates 206, 208. The first and second plates 206-208 releasably clamp about one end of the the insulating housing 222, which acts to thermally insulate from the pipe 224, portions of a filament (not shown) that have not yet been advanced to the pipe 224. As explained above, a portion of the pipe 224 distal from the block 209 formed by the first and second clamp plates 206-208 is heated to convert the fiber material that is inserted within it from a solid state to a liquid state. The insulating housing 222 in which the pipe 224 is housed reduces transfer of heat from the pipe 224 to the plates 206, 208 thereby preventing premature melting of the solid filament. Premature melting of the filament could cause problems such as premature loss of structural rigidity of the filament making it difficult to controllably advance the filament using a drive mechanism 201-1, 202-2 and causing jamming, for example. The first and second plates 206, 208 clamp the housing 222 with the pipe 224 disposed inside in a fixed position so as to align in a straight line a shared junction portion 226 at a confluence of the first and second filament passages 210-1, 210-2 and the plunger guide passage 212 on the one hand and the phase change passage 216 defined by the insulating housing 222 and the pipe 224 on the other hand.

More particularly, in some embodiments, the first and second filament passages 210-1, 210-2 follow paths that converge with each other and with the path of the plunger guide passage 212 at the junction region 226 adjacent to an opening to the phase change passage 216. In some embodiments, the first filament guide passage defines a first filament opening 228-1 adjacent the first filament drive mechanism 202-1, and the second filament guide passage 210-2 defines a second filament opening 228-2 adjacent the second drive mechanism 201-2. The plunger guide passage 212 defines a plunger member opening 229 between the first and second filament openings.

In some embodiments, the elongated rod 234 is driven to act as a plunger that is selectively inserted into and retracted, via the plunger passage 212, to and from the shared portion 226 of the filament passages. In some embodiments, the cylindrical rod has a range of motion and a length sufficient so that it also can be selectively inserted into and retracted from the phase change guide passage 216. In some embodiments, the path of the plunger guide passage 212 bisects the paths of the first and second filament guide passages 210-1, 210-2.

The first and second filament drive mechanisms 202-1, 202-2 are disposed spaced apart laterally from each other by an amount sufficient to allow room for a piston drive mechanism 230 disposed between them. In some embodiments the piston drive mechanism 230 comprises a solenoid (not shown) that imparts axial motion to a piston member 232 that includes an elongated rod 234 that acts as a plunger that is sized to slidably move within the plunger guide passage 212. The first and second clamp plates 206, 208 define a collar halves 236-1, 236-2 that interfit together about an insertion end 238 of the piston drive mechanism 230 to secure it in place with the elongated rod 234 aligned with the plunger guide passage 212. Alternatively, a motor, for example, can be used to impart motion to the elongated rod within the plunger guide passage 212.

In some embodiments, the respective first and second filament guide passages 210-1, 210-2 follow respective curved paths between the respective spaced apart first and second filament openings 228-1, 228-2 and the shared passage portion 226. An acceptable bend radius range for the curved passages may depend upon the hardness of the filament materials to be inserted through the filament guide passages 210-1, 210-2. In general, the harder the filament material, the larger the minimum required bend radius for the filament passage. It will be appreciated that a curvature of the filament guide passages 210-1, 210-2 is selected to permit insertion of the filament with a filament axis aligned at an angle to the shared passage 226 and to gradually guide a filament inserted therein in a curved path to bend the filament as it moves within a filament guide passage so that an axis of the filament is aligned with an axis of the phase change guide passage 216 upon reaching the shared junction 226. In some embodiments, the plunger guide passage 212 provides a straight path to allow motion of the elongated rod 234, which acts as a plunger to clean out residual melted or semi-melted filament residue.

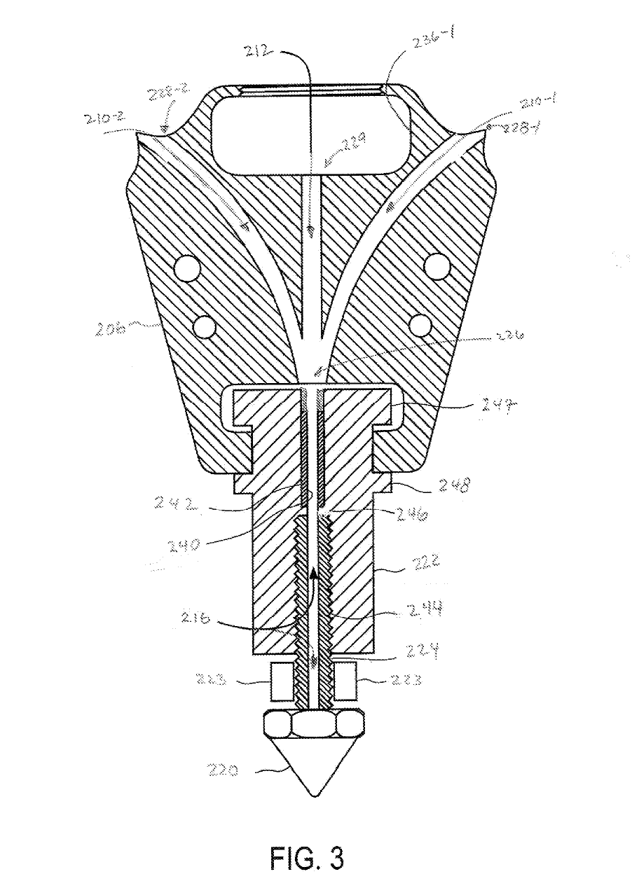

FIG. 3 is an illustrative partial cross sectional view of the hot end element groove mounted within the first clamp plate of FIGS. 2A-2C in accordance with some embodiments. The nozzle 220 is mounted at a distal end of the pipe 224. The housing 222 and pipe 224 arranged with the nozzle mounted on the pipe are known in the art. The housing 222 is formed of high strength heat insulating material, such as PEEK, for example, for structural strength. The housing defines two inner tube sections. A smaller diameter first inner tube section 240 is lined with a low friction, low strength, heat insulating material 242 such as PTFE, for example, to provide for low friction movement of the filament therethrough. A wider diameter second inner tube section 244 is sized to receive the pipe 224. The housing 222 defines an inner shoulder 246 at the interface of the first and second inner tube sections 240, 244. The pipe 224 and the second inner tube section 244 are threaded so that the pipe can be screwed securely within the housing with a first end of the pipe abutting the inner shoulder 246 and a second end extending outward from the housing and being secured to the nozzle 220. It will be noted that a portion of the pipe adjacent the shoulder is smooth as is a corresponding portion of the second inner tube.

The housing 222 is generally cylindrical in shape and defines a first (upper) outward extending annular ring 247 and second (lower) outward extending annular ring 248. The first and second annular rings 247, 248 extend outwardly about the region of the housing. The annular rings 247, 248 define a mounting slot 250 sized to snugly interfit with corresponding complementary annular recessed surfaces regions 252-1, 252-2 formed in the first and second plates 206, 208. It will be appreciated that the low thermal conductivity housing 222, when groove mounted between the first and second plates 206, 208, acts to thermally insulate the plates and a filament (not shown) guided within the first and second filament guide passages 210-1, 210-2 defined by the clamped-together plates 206, 208 therein from the heated pipe 224.

Each of the first and second drive mechanisms 202-1, 202-2 includes a drive roller and an idler roller that are disposed to capture a filament between them. The first drive mechanism 202-1 captures a first filament (not shown) between a first drive roller 254-1 and a first idler roller 256-1 with the first filament (not shown) in alignment with the first filament opening 228-1 to the first filament guide passage 210-1. The second drive mechanism 202-2 captures a second filament (not shown) between a second drive roller 254-2 and a second idler roller 256-2 with the second filament (not shown) in alignment with the second filament opening 228-2 to the second filament guide passage 210-2. The first and second drive rollers 254-1, 254-2 are driven by the first and second motors 204-1, 204-2. In some embodiments, the first drive roller 254-1 is mounted upon a first motor shaft 258-1, and the second drive roller 254-2 is mounted upon a second motor shaft 258-2.

Referring now to the first drive mechanism 202-1, the first idler roller 256-1 is rotatably mounted upon a first end of a first beam 260-1. A second beam 262-1 is fixedly secured to a mounting platform 259. The first beam 260-1 is mounted to rotate about a pivot pin 264 that is secured to and upstands perpendicular to a main axis of the second arm 262-2. The pivot pin 264 is disposed between a first end and a second end of the first arm 260-1. A coil spring 266 is disposed about the pivot pin 264-1. The spring 266-1 has a first spring leg 268-1 that abuts a portion of the rotatably mounted first beam 260-1 adjacent the second end of the first beam. The spring 266-1 has a second spring leg 270-1 that abuts a portion of the fixedly mounted second beam 262-1, which acts as a fixed fulcrum block. The spring 266-1 urges the first beam 260-1 with the mounted idler roller 256-1 to press a filament (not shown) firmly against the drive roller 254-1. In order to insert or remove a filament from between the drive roller 254-1 and the idler roller 256-1, a force is applied (as with one's thumb for example) to the second end of the first beam 260-1 (i.e. the end opposite the first end on which the idler roller 256-1 is mounted) so as to rotate the first beam 260-1 about the pivot pin 264-1 so that its first end with the idler roller 256-1 rotates away from the drive roller 254-1 allowing a filament to be inserted or removed. In operation during printing, rotation of the drive roller 254-1 imparts a force to the filament (not shown) that pulls the filament towards or away from the first filament guide passage 210-1, depending upon the direction of rotation of the drive roller 254-1.

The second drive mechanism 202-2 includes components that are structurally and functionally like those of the first drive mechanism 202-1 and will be understood by a persons skilled in the art without further explanation.

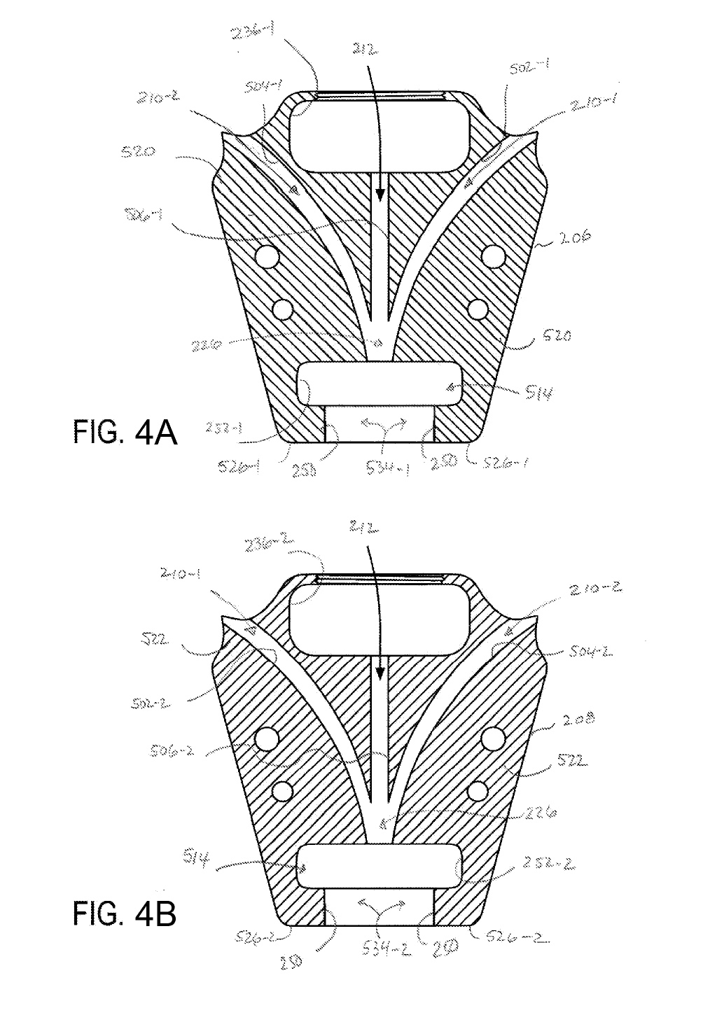

FIGS. 4A-4B are illustrative drawings that show first opposed facing surfaces 520, 522 of the high thermal conductivity clamp plates 206, 208 in accordance with some embodiments. The first and second plates 206, 208 are assembled together to produce the block 209 that comprises the two plates 206, 208 and that together define the first and second filament guide passages 210-1, 210-2, the plunger guide passage 212, an insulating housing mount portion 514 defined generally by the recessed surfaces 252-1, 252-2. Inner facing surfaces 520, 522 of the plates are substantially planar so as that they closely fit together when placed into abutment with each other. In some embodiments, the first and second plates 206, 208 are formed of metal, specifically, aluminum. Alternatively, the plates could be formed of a different material that is highly thermally conductive and easily machined such as copper, for example. The first plate 206 includes an inner facing top surface 520 and an outer facing bottom surface (not shown). The second plate 208 includes an inner bottom 522 surface and an outer facing top surface 524. The annular recessed surface regions 252-2, 252-4 formed in inner facing surfaces 520, 522 are sized to receive the outward extending (upper) annular ring 247 of the housing 222 and to form a circular shelf-like mounting slot 250 for insertion between the upper and lower annular rings 247, 248 of the housing 222. It will be understood that orientations used herein such as top or bottom or side are for reference purposes only and that actual orientation may vary depending upon positioning of the print head components when in actual use.

The clamp plates also define a recessed collar region 236-1, 236-2 to receive and to clamp therebetween the insertion end 238 of the piston drive mechanism 230 as described above.

Each of the first and second filament guide passages 210-1, 210-2 is generally cylindrical in contour and is sized to guide movement of a filament (not shown) through it. In some embodiments, the first and second filament guide passages 210-1, 210-2 have diameters that are wide enough to allow smooth uninterrupted movement of a filament and that are narrow enough to prevent bending, crimping or bunching of the filament during such movement. In some embodiments, contours of the respective first and second filament guide passages adjacent the respective first and second filament openings 228-1, 228-2 are tapered so as to be wider where the filaments enter the openings and so as to smoothly taper down to a narrower diameter nearer the junction 226 between the first and second filament guide passages, that is suitable for movement of the filament without bending, crimping or bunching.

The first and second plates 206, 208 also define opposed halves of a mounting portion 514. Each plate forms half of the cylindrical walls of the mounting slot 250, a cylindrical recess 534-1, 534-2 sized to receive the housing 222, which is cylindrical in shape in some embodiments. In addition, the annular recessed surfaces regions 252-1, 252-2 of the plates 206, 208 form an annular recess sized to receive the first outward extending (upper) ring 247 of the housing 222 so as to provide a groove mount surface with the housing 222 clamped. When the two plates are clamped together, the housing 222 can be clamped between them with the first, upper, outward ring seated within the annular recess, with a portion of the housing body seated within the cylindrical recesses 534-1, 534-2 and with the second (lower) annular ring 248 abutting bottom surfaces 526-2 of the plates 206, 208 that face the dispensing nozzle 206.

In some embodiments, the first and second plates 206, 208 are releasably secured to each other, using removable fasteners such as screws for example, with the low thermal conductivity housing 222 clamped between them. The first plate 206 is secured to a first surface of a generally planar mounting platform 259 with a bottom facing surface (not shown) of the first plate 206 abutting against the platform 259. In some embodiments, the clamp plates can be taken apart through use of easily accessible fasteners (not shown) that secure the plates together so that the interior guide passages can be cleaned of residual partially melted filament material and to remove or replace the hot end. 214, for example. It will be appreciated that providing matching clamp plates that are easily accessible to users, to define the multiple different guide passages facilitates ease of maintenance of those guide passages.

As explained above, in some embodiments the first and second plates 506, 508 are formed of a high thermal conductivity material such as aluminum or copper, for example. The high thermal conductivity plates can act as a heat sink for the housing 222 and other parts in the hot end. The close interfit between the housing 222 and the plates 206, 208 facilitates the transfer of heat from the housing to the plates. The plates' action in sinking heat can prolong the service life of the housing 222 and the hot end by reducing heat. Reduced heating can result in less clogging of the first and second filament guide passages with re-solidified material. Also, the inner low friction layer 242 can degrade if exposed to high temperatures for extended periods, and the plates' sinking heat from the housing sometimes can extend its life, for example.

It will be appreciated that although only two sets of filament guide passages, motors and drive mechanisms are employed in the disclosed embodiment, the same principles can be applied with a greater number of sets of these.

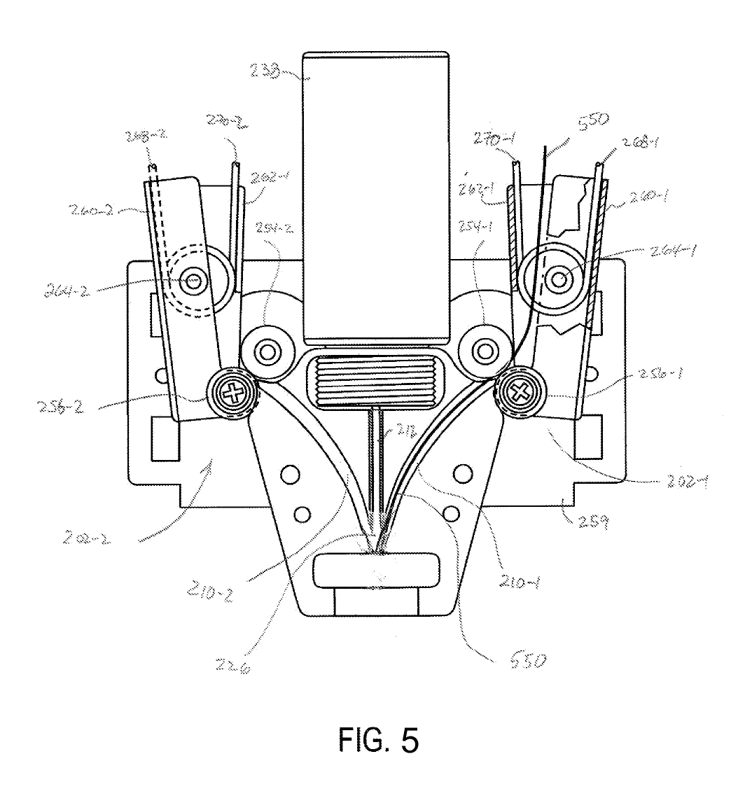

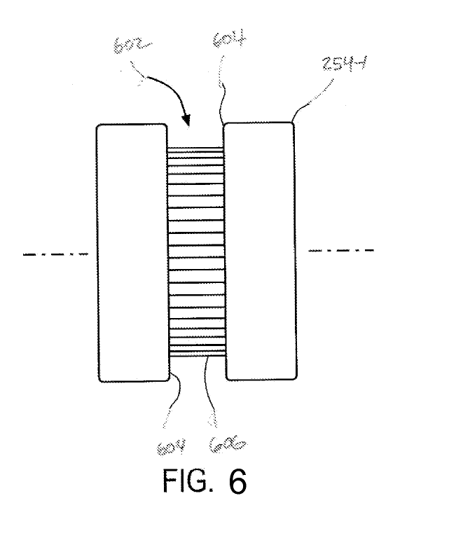

FIG. 5 is an illustrative view of a portion of the side elevation view of FIG. 2B but with the second (top) plate removed to show the upper face of the first (bottom) clamp plate and showing the spring and lever mechanisms partially in cut away and partially with phantom lines in accordance with some embodiments. The drawing of FIG. 6 shows the relationships among the first drive mechanism 202-1 and the first filament guide passage 210-1; shows the relationships among the second drive mechanism 202-2 and the second filament guide passage 210-2; and shows the relationship between the piston drive mechanism 238 and the plunger guide passage 212. The drawing of FIG. 6 also shows the confluence of the three guide passages at the junction region, which is adjacent the entry to the hot end (not shown). A filament 550 is shown inserted into the first filament guide passage 210-1. Details of the operation of these components are explained above.

FIG. 6 is a side view of a driver roller 254-1 in accordance with some embodiments. The driver roller is circumscribed with an annular groove 602 having side walls 604. A bottom surface 606 of the annular groove 602 is textured to increase frictional gripping action. In some embodiments, the textured surface comprises a knurled pattern in the form of a series of ridges oriented axially parallel to the spindle axis. In other embodiments, the knurled pattern may comprise a crisscross pattern, for example.

Returning again to FIGS. 2A-2C, the first and second idler rollers 256-1, 256-2 have smooth perimeters (not shown) that acts as a low friction rotatable bearing surfaces, in concert with the high friction textured surface of the respective first and second drive rollers 254-1, 254-2, to feed respective first and second filaments (not shown) into the respective first and second filament openings 228-1, 228-2.

A computer 126 controls heat supplied to a filament material in the liquefier portion of the hot end. The liquefier includes a heating element 223 that is controlled by the computer and that is coupled to heat the pipe 224 to transmit to it sufficient heat convert a solid filament entering from the first guide passage to a liquid within the second guide passage. A heat sensing element (not shown) such as a negative temperature coefficient (NTC) thermistor or a thermocouple provides temperature information to the computer used to determine the heat to be provided. Details of operation of the liquefier are known to persons skilled in the art and need not be provided herein. In operation, the respective drive roller/idler roller pairs 254-1/256-1 and 254-2/256-2 alternate in driving filaments into the respective openings 228-1, 228-2. In some embodiments, a first filament is inserted between the first driver and idler wheels within the first drive mechanism, and a second filament is inserted between the first driver and idler wheels within the second drive mechanism. At some given time, one of the two filaments is selected by the computer to be driven so as to feed the filament into its respective filament guide passage while the overall device including its nozzle 220 is moved in one or more of X and Y directions, and the platform on which the in-production object is mounted may be moved in the Z direction. It will be appreciated that at a later time, the other filament will be selected, as explained below. As the selected filament passes through its filament guide passage, it melts as at passes through the melt-chamber, and molten material is extruded onto the structure that is being created or manufactured.

The selected filament follows along its respective filament guide passage to the junction region 226 and into the hot end 214. The heating element 223 heats the filament (not shown) causing it to melt to a fluid state. The dispensing nozzle 220 deposits the melted filament material to a surface of an object that is under construction. During the filament feeding, heating and extrusion process, the insulating housing 222 acts to reduce transmission of heat to the filament, and the metal plates 206, 208 act to sink heat away from the filament.

Once the print cycle for the selected filament is complete, and it is time to select the other filament, a transition sequence commences in which the nozzle 220 is temporarily moved to a position in which it is not disposed over the object that is under construction. One reason for the positioning of the nozzle in this manner is so that excess molten material left over from extrusion of the first-selected filament does not drip onto the object in locations where it should not be deposited. The drive mechanism that drives the filament that is at the end of its current run is reversed so as to pull back the end portion of the selected filament far enough so that a non-melted portion of that filament is pulled back beyond (i.e. above) the junction 226. A result of this pull-back is that some molten or semi-molten filament material typically is pulled back out of the melt-chamber and into the junction region 226. Ideally, the pull back of the filament is not far enough to pull this melted filament portion all of the way into a portion of that filament's filament guide passage that is disposed above the junction 226.

The piston drive 230 is actuated so as to drive the piston rod 234 into the junction 226 thereby slicing or cutting off any melted or partially melted, sometimes stringy, filament residue from the still solid filament that has been pulled back into its filament guide passage. In some embodiments, the rod 234 is pushed into the melt-chamber passaged defined by the pipe 224 and housing 222 far enough so that it forces excess filament residue out the extruder nozzle 220, but not so far that the rod 234 actually enters the melt-chamber itself. One reason for not forcing the rod 234 more deeply in is that it could become lodged or stuck within the melted goo in the melt-chamber. This is a particular concern where less power is available to pull the rod back out if it gets lodged in the melted material. Once the rod 234 has been plunged into the melt-chamber passage, the filament that has reached the end of its current run is pulled back even further into its filament guide so as to separate it from any remaining melted filament residue that may still cling to it. Next, the rod 234 is pulled back out of the melt-chamber passage and out of the junction region 226 so as to leave a clear path. Finally, the other filament is driven into its filament guide passage and extrusion of molten material from that other filament proceeds as generally described above.

The foregoing description and drawings of embodiments in accordance with the present invention are merely illustrative of the principles of the invention. Therefore, it will be understood that various modifications can be made to the embodiments by those skilled in the art without departing from the spirit and scope of the invention, which is defined in the appended claims.

What is claimed is:

1. An apparatus to receive a filament material and to move the filament while guiding a direction of movement of the filament comprising:
a metal block that defines a first guide passage sized to receive a first filament and that defines a second guide passage sized to receive a second filament and that defines a plunger passage, wherein the first and second guide passages intersect to define a shared junction, and wherein the plunger passage passes through the shared junction;
wherein the block includes a first plate that includes a first surface that defines first grooves and includes a second plate that includes second surface that defines a second grooves; and
wherein the first and second faces of the first and second plates are in abutting contact with the first and second grooves aligned to define the first guide passage, the second guide passage and the plunger passage;
a drive mechanism configured to move the first and second filaments into the first and second guide passages guide passage;
a plunger sized to pass within the plunger passage; and
a drive mechanism to drive a plunger through the plunger passage.
